(19) United States
(12) Patent Application Publication
(10) Pub. No.: US 2012/0291212 A1
(43) Pub. Date: Nov. 22, 2012

(54) RESONANT VIBRATION-ENHANCING CLEANING ATTACHMENT FOR AN ULTRASONIC POWERED HANDLE

(76) Inventor: James G. Montagnino, St. Charles, IL (US)

(21) Appl. No.: 13/473,115

(22) Filed: May 16, 2012

Related U.S. Application Data
(60) Provisional application No. 61/457,694, filed on May 16, 2011.

(51) Int. Cl. A46B 9/04; A46B 17/08; B23P 6/00; A46B 13/00

(52) U.S. Cl. 15/167.1; 15/246; 15/236.01; 29/592.1

(57) ABSTRACT

A cleaning attachment for an ultrasonic powered handle includes a shaft mounting a cleaning implement (brush or scraper) at a tip end and either two parallel transverse channels in a front surface near the cleaning implement, or two parallel transverse channels in opposite side surfaces, so as to increase the resonant vibrational frequency of the cleaning implement beyond that expected from vibration generated by the ultrasonic powered handle.

### CROSS-REFERENCE TO RELATED APPLICATION

This application derives from (and claims the benefit of) U.S. provisional application No. 61/457,694, filed May 16, 2011, the content of which is hereby incorporated by reference.

### BACKGROUND OF THE INVENTION

1. Field of the Invention

This invention relates to electrically-powered cleaning devices, and more particularly to hand-held ultrasonic personal care cleaning devices.

2. The Prior Art

Hand-held electrically-powered personal care cleaning devices are well known and commonly available throughout the developed world. Such personal care cleaning devices include ultrasonic toothbrushes, ultrasonic tongue cleaners and ultrasonic facial skin brushes. These ultrasonic devices generate vibrations by a motor operating a rotary mechanism, the motor being powered by an attached battery pack, a contained rechargeable battery, or by a power chord connected to a wall outlet. The effectiveness of these devices is related to the resonant frequency of the vibration of the implement (e.g., brush or scraper) at the tip end of the attachment shaft connected to the powered handle. Typically, the motor in the powered handle will operate at 1,550-1,650 rpm and provide 31,000-33,000 back-forth strokes. And typically this cannot be changed.

U.S. Patent Application Publication 2003/0208870 A1 discloses a toothbrush attachment for an electric handle which includes a neck having a pivot joint formed of multiple rings and intermediate valleys or connecting sections creating an undulated outer surface (see FIG. 8). This enables the head to which a cleaning element is attached to move in various directions and have improved surface contact or reach to areas of the mouth, teeth or gum line by flexing to create more uniform surface contact or improve user ergonomics. Nothing is mentioned regarding resonant frequency of the head of the toothbrush attachment.

### SUMMARY OF THE INVENTION

The applicant has discovered that, in one embodiment, by including two parallel, transversely-extending channels (flex grooves) in a front surface of the mounting shaft between its base end and the implement attached to its tip end, the resonant frequency of vibration of the tip end and the connected implement in a forward and rearward direction is significantly increased. He has also discovered that, in a second embodiment, by including two parallel, transverse channels in the opposite side surfaces of the mounting shaft between its base end and the implement attached to its tip end (the channels on opposite sides being in register), resonant frequency of vibration of the tip end and the implement attached thereto is significantly increased in a side-by-side (lateral) direction. The channels can be provided in the mounting shaft during manufacture (molding) or machined therein after manufacture. The channels advantageously have semicircular cross sections which are the same or different. The implements are for personal care, i.e., brushes for cleaning teeth, scrapers for cleaning tongues (oral cleaning implements), or brushes for removing facial skin. Only two parallel channels on the front surface, or two parallel channels on the opposite side surfaces are used. If only a single channel is present, the vibrational increase is not achieved, and if more than two are present, an undesirable weakening of the attachment shaft can occur.

Further features and advantages of the invention will become apparent by reference to the accompanying drawings taken with the following discussion.

### BRIEF DESCRIPTION OF THE DRAWINGS

FIGS. 1a-1e depict a resonance-enhancing cleaning attachment according to a first embodiment of the present invention, FIG. 1a showing a side view, FIG. 1b showing a rear view, FIG. 1c showing a front view, FIG. 1d showing a tip end view, and FIG. 1e showing a base end view,

FIGS. 2a-2c depict the cleaning attachment of FIGS. 1a-1e attached to an ultrasonic powered handle, FIGS. 2a showing a side view, FIG. 2b showing a rear view, and FIG. 2c showing a front view,

FIGS. 3a-3c depict a second embodiment of a cleaning attachment according to the present invention, FIG. 3a showing a side view, FIG. 3b showing a front view, and FIG. 3c showing a tip end view,

FIGS. 4a-4b depict the cleaning attachment of FIGS. 3a-3c attached to an ultrasonic powered handle,

FIGS. 5a and 5b depict a third embodiment cleaning attachment according to the present invention when attached to an ultrasonic powered handle, FIG. 5a showing a side view, and FIG. 5b showing a front view,

FIGS. 6a and 6b depict a fourth embodiment of a cleaning attachment according to the present invention when attached to an ultrasonic powered handle, FIG. 6c showing an alternative head implement,

FIG. 7 illustrates the motion of a standard ultrasonic powered handle and the resulting motion created by the inventive parallel channels,

FIG. 8 illustrates the motion amplification of the attachment according to the present invention compared to an attachment which has no flex hinges, and

FIGS. 9a-9c show further views of the embodiments of cleaning attachments depicted in FIGS. 1a-1e, 3a-3c and 6a-6b.

### DETAILED DISCUSSION OF THE PREFERRED EMBODIMENTS

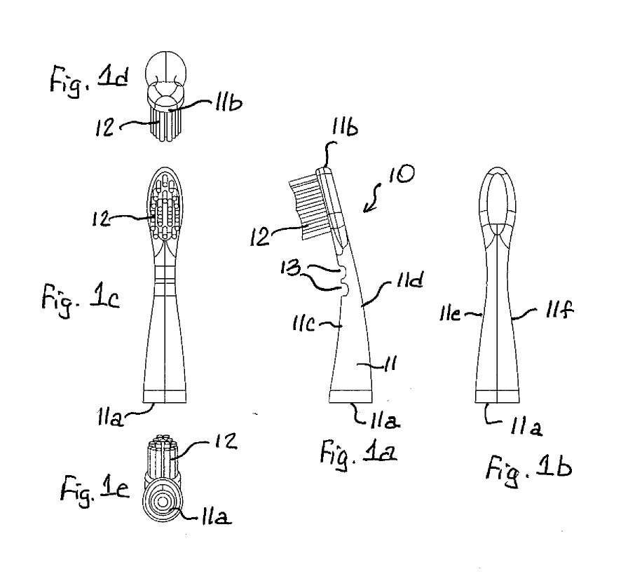

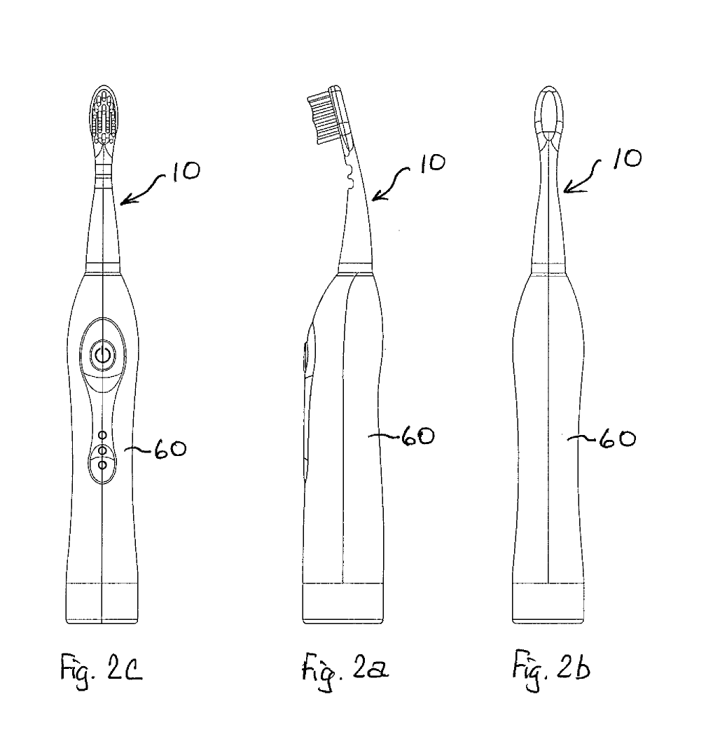

A first embodiment of a resonant-frequency-enhancing cleaning attachment 10 for an ultrasonic powered handle according to the present invention is shown in FIGS. 1a-1e. It includes an ergonomic attachment shaft 11 having a base end 11a, a tip end 11b on which a brush 12 (for brushing teeth) is mounted, a front surface 11c which curves from the base end 11a towards the brush 12, a rear surface 11d which also curves from the base end 11a towards the tip end 11b, and opposite side surfaces 11e and 11f which are curved, first towards each other, then away from each other, and then together, as they extend from the base end 11a to the tip end 11b. The base end 11a is hollow and constructed to connect to and around a projection from an ultrasonic powered handle 60 (see FIGS. 2a-2c). Two parallel channels 13 are provided in the front surface 11c of the cleaning attachment near the brush 12, these channels extending transversely (perpendicularly) to a center plane through the attachment shaft. These channels have semicircular cross sections, and they act to increase the resonant frequency of vibration of the brush 12 in a forward-rearward direction when vibrated by an ultrasonic powered handle. In a useful example the attachment shaft is 76.61 mm in length and the first channel starts at 36.75 mm from the base end. The radius of the first channel is 1.6 mm and that of the second channel is 0.5 mm.

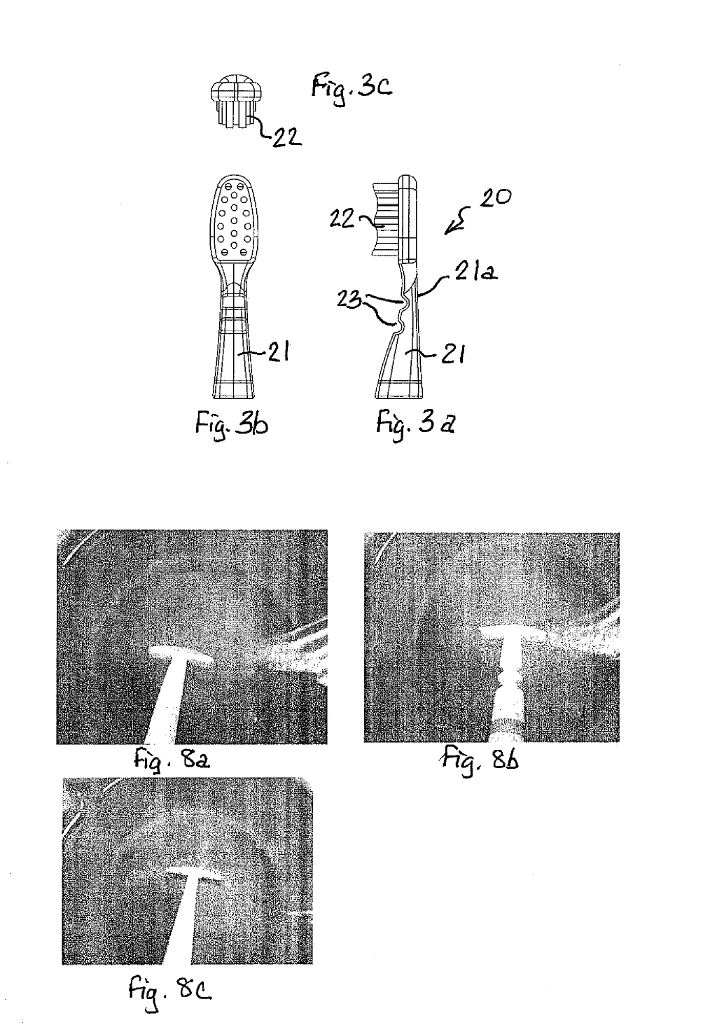

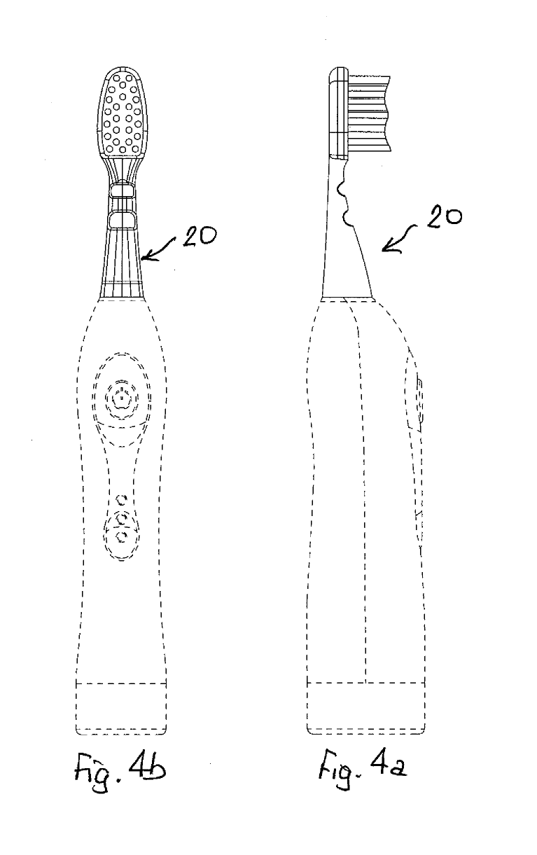

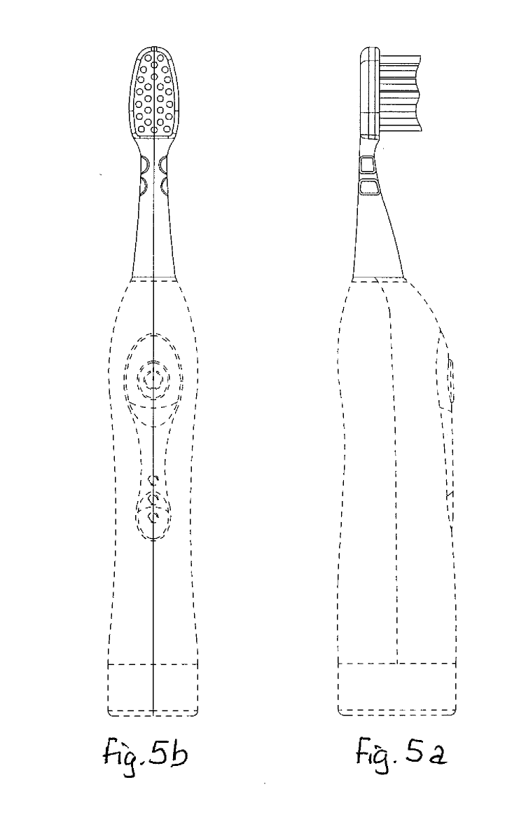

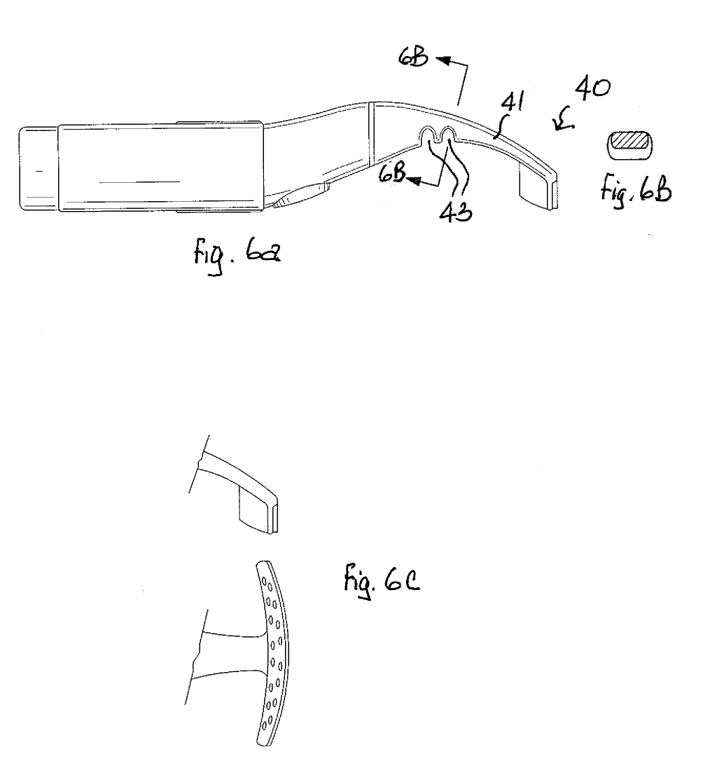

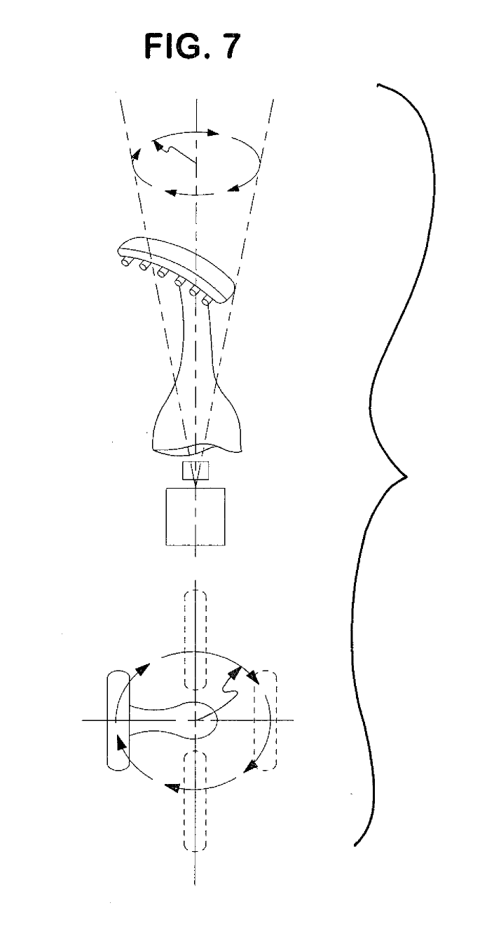

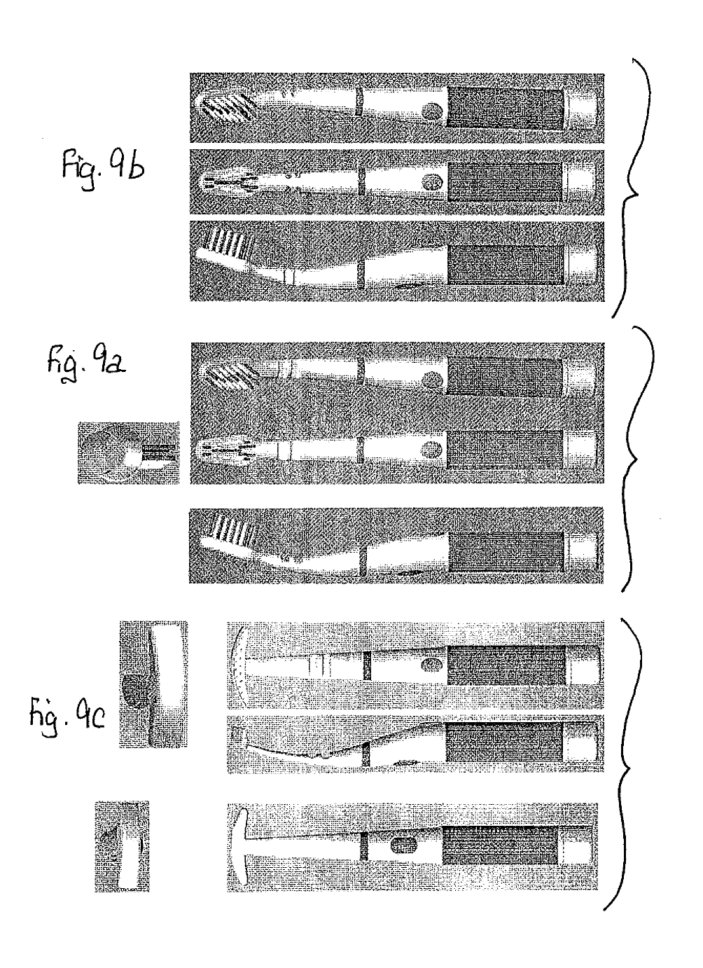

FIGS. 3a-3c depict a second embodiment of inventive resonant frequency-enhancing cleaning attachment 20 which is similar to the first embodiment except that the rear surface 21d of the shaft 21 is straight. This embodiment is similarly attachable to an ultrasonic powered handle 60 (see FIGS. 4a-4b). In an example wherein the attachment shaft is 68 mm in length, the first channels are centered at 32 mm from the base end and the second channels are centered at 38.88 mm from the base end. The first channel has a radius of 2 mm and the second channel has a radius of 1.5 mm.

A third embodiment of inventive resonant vibration-enhancing cleaning attachment is shown in FIGS. 5a and 5b. It is a toothbrush attachment 30 which is similar to the second embodiment except the attachment shaft 31 has two parallel channels 33 in each of its opposite sides 31e and 31f with the pairs of channels in each side surface being in register with one another. These channels enhance the resonant frequency of vibration in a side-to-side (lateral) direction. In an example wherein the attachment shaft is 68 mm in length, the first channels are centered at 35 mm from the base end and the second channels are centered at 40 mm from the base end. The first channels have a radius of 2 mm and the second channels have a radius of 0.5 mm.

A fourth embodiment of inventive resonant vibration-enhancing cleaning attachment is shown in FIGS. 6a and 6b. It is a tongue cleaner attachment 40 which is similar to the first embodiment except that the shaft 41 mounts a curved scraper 42.

Although specific embodiments of the present invention have been shown and described, variations therein can be made and still fall within the scope of the appended claims.

I claim:

1. A cleaning attachment for an ultrasonic powered handle which comprises:
a shaft having a tip end for mounting of a cleaning implement, a base end for attachment to an ultrasonic powered handle, a front surface, a rear surface and opposite side surfaces, and
a cleaning implement mounted on said front surface at said tip end of said shaft,
said front surface of said shaft including two transverse parallel channels near said cleaning implement which increase resonant frequency of vibration of said cleaning implement when said attachment shaft is attached to and vibrated by an ultrasonic powered handle.

2. The cleaning attachment as defined in claim 1, wherein said transverse parallel channels have identical semicircular cross sections.

3. The cleaning attachment as defined in claim 1, wherein said cleaning implement is a brush for cleaning teeth.

4. The cleaning attachment as defined in claim 1, wherein said cleaning implement is a tongue scraper.

5. The cleaning attachment as defined in claim 1, wherein said rear surface of said shaft is forwardly curved from the base end towards the tip end.

6. The cleaning attachment as defined in claim 1, wherein said rear surface of said shaft is straight.

7. The cleaning attachment as defined in claim 1, wherein said shaft has a cross section which decreases from said base end towards said channels.

8. A cleaning attachment for an ultrasonic powered handle which comprises:
a shaft having a tip end for mounting of a cleaning implement, a base end for attachment to an ultrasonic powered handle, a front surface, a rear surface and opposite side surfaces, and
a cleaning implement mounted on said front surface at said tip end of said shaft,
each of said side surfaces of said shaft including two transverse parallel channels near said cleaning implement which increase resonant frequency of vibration of said cleaning implement when said attachment is attached to an vibrated by an ultrasonic powered handle, the channels of the opposite side surfaces being in register.

9. The cleaning attachment as defined in claim 8, wherein said transverse parallel channels have identical semicircular cross sections.

10. The cleaning attachment as defined in claim 8, wherein said cleaning implement is a brush for cleaning teeth.

11. The cleaning attachment as defined in claim 8, wherein said cleaning implement is a tongue scraper.

12. The cleaning attachment as defined in claim 8, wherein said rear surface of said shaft is curved from the base end towards the tip end.

13. The cleaning attachment as defined in claim 8, wherein said rear surface of said shaft is straight.

14. The cleaning attachment as defined in claim 8, wherein said shaft has a cross section which decreases from said base end towards said channels.

15. A method of increasing resonant frequency of vibration of a cleaning implement mounted at a tip end of an attachment shaft having a base end mountable on an ultrasonic powered handle, a front surface, opposite side surfaces, and a rear surface, said method comprising:
forming two parallel transverse channels in said front surface of said shaft.

16. The method of claim 15, wherein said two parallel transverse channels are formed during molding of the attachment shaft.

17. The method of claim 16, wherein said channels have identical semicircular cross sections.

18. A method of increasing resonant frequency of vibration of a cleaning implement mounted at a tip end of an attachment shaft having a base end mountable on an ultrasonic powered handle, a front surface, opposite side surfaces, and a rear surface, said method comprising
forming two parallel transverse channels in each of said opposite side surfaces of said shaft so as to be in register with one another.

19. The method of claim 18, wherein said parallel transverse channels are formed during molding of the attachment shaft.

20. The method of claim 19, wherein said channels have identical semicircular cross sections.
